(19) United States
(12) Patent Application Publication
(10) Pub. No.: US 2023/0261173 A1
(43) Pub. Date: Aug. 17, 2023

(54) LITHIUM METAL ANODES FOR USE IN ELECTROCHEMICAL CELL AND METHODS OF MAKING THE SAME

(71) Applicant: GM GLOBAL TECHNOLOGY OPERATIONS LLC, Detroit, MI (US)

(72) Inventors: Caleb REESE, Ferndale, MI (US); Leng MAO, Troy, MI (US); Andrew Clay BOBEL, Troy, MI (US); Jeffrey David Cain, Royal Oak, MI (US)

(73) Assignee: GM GLOBAL TECHNOLOGY OPERATIONS LLC, Detroit, MI (US)

(21) Appl. No.: 17/673,437

(22) Filed: Feb. 16, 2022

(51) Int. Cl. H01M 4/134; H01M 10/0525; H01M 4/38; H01M 4/04

(52) U.S. Cl. CPC H01M 4/134; H01M 10/0525; H01M 4/382; H01M 4/0492; H01M 4/044; H01M 2004/021

(57) ABSTRACT

An electrode including an electrochemical layer defining a surface having a plurality of dimples formed thereon is provided. The dimples have an average lateral size greater than or equal to about 100 nm to less than or equal to about 100 μm, and an average depth greater than or equal to about 100 nm to less than or equal to about 50 μm. In certain variations, the dimples are formed in situ by applying a current to the electrochemical layer. In other variations, the dimples are formed by moving a roller having a plurality of shapes defined thereon along one or more surfaces of the electrochemical layer. In still other variations, the dimples are formed by contacting one or more surfaces of the electrochemical layer with a chemical etchant.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Batteries are configured to reversibly supply power to an associated load device. For example, electrical power can be supplied to a load device by a battery until the lithium content of the negative electrode (i.e., anode) is effectively depleted. The battery can then be recharged by passing a suitable direct electrical current in the opposite direction between the electrodes. More particularly, during discharge, the negative electrode includes relatively high concentration of deposited or plated lithium that can be oxidized into lithium ions and electrons. The lithium ions can travel from the negative electrode to the positive electrode (i.e., cathode), through the (ionically conductive) electrolyte solution contained, for example, within the pores of an interposed separator. Once there, the lithium ions can be assimilated into the positive electroactive material by electrochemical reduction reactions. As the lithium ions travel from the negative electrode to the positive electrode, the electrons can pass through an external circuit from the negative electrode to the positive electrode.

In comparison, during recharge, intercalated lithium in the positive electrode can be oxidized into lithium ions and electrons, and the lithium ions travel from the positive electrode to the negative electrode, for example, through the separator via the (ironically conductive) electrolyte, and the electrons pass through the external circuit to the negative electrode. Once there, the lithium ions can be reduced to elemental lithium in the negative electrode and stored for future use. The battery may be recharged after any partial or full discharge of its available capacity by an external power source. As noted, recharging can reverse electrochemical reactions that transpired during discharge.

During various discharge and recharge processes, undesirable metal plating and dendrite formation often occurs, for example, as a result of the degradation of the active materials (e.g., negative electrode, positive electrode, and electrolyte), creating unusable or dead lithium. The metal dendrites may form protrusions that potentially puncture the separator and cause, for example, an internal short circuit, which can cause low Coulombic efficiencies, poor cycle performances, and potential safety issues. Accordingly, it would be desirable to develop materials for use in high energy lithium ion batteries that reduce metal dendrite formation and similarly suppress or minimize its effects.

### SUMMARY

This section provides a general summary of the disclosure, and is not a comprehensive disclosure of its full scope or all of its features.

The present disclosure relates to electrochemical cells including lithium-metal electrodes having predetermined surface designs for preferential lithium nucleation during cell operation, and methods of making and using the same.

In various aspects, the present disclosure provides an electrode for use in an electrochemical cell that cycles lithium ions. The electrode may include an electrochemical layer that defines a surface having a plurality of dimples. The electrochemical layer may include lithium metal. The dimples of the plurality of dimples may have an average lateral size greater than or equal to about 100 nm to less than or equal to about 100 μm, and an average depth greater than or equal to about 100 nm to less than or equal to about 50 μm.

In one aspect, the dimples of the plurality of dimples may occupy greater than or equal to about 20% to less than or equal to about 90% of a total surface area of the one or more surfaces.

In one aspect, the dimples of the plurality of dimples may be randomly distributed on the one or more surfaces of the electrochemical layer.

In one aspect, the dimples of the plurality of dimples may be dispersed with a uniform density on the one or more surfaces of the electrochemical layer.

In one aspect, the dimples of the plurality of dimples may define one or more patterns along the one or more surfaces of the electrochemical layer.

In various aspects, the present disclosure provides a method for forming an electrode for use in an electrochemical cell that cycles lithium ions. The method may include forming a plurality of dimples on one or more surfaces of a precursor electrochemical layer to form an electrochemical layer. The dimples of the plurality of dimples may have an average lateral size greater than or equal to about 100 nm to less than or equal to about 100 μm, and a depth greater than or equal to about 100 nm to less than or equal to about 50 μm. The electrochemical layer may include lithium. The electrode may include the electrochemical layer.

In one aspect, the forming may include applying a current density greater than or equal to about 0.1 mA/cm² to less than or equal to about 10 mA/cm² to the precursor electrochemical layer. The current density may be applied for a time greater than or equal to about 1 second to less than or equal to about 20 minutes.

In one aspect, the method may further include assembling a cell, where the cell includes the precursor electrochemical layer.

In one aspect, the forming may include moving a roller having a plurality of shapes defined thereon along one or more surfaces of the precursor electrochemical layer.

In one aspect, the method may further include assembling a cell, where the cell includes the electrode.

In one aspect, the forming may include contacting one or more surfaces of the precursor electrochemical layer and a chemical etchant. The precursor electrochemical layer may be contacted with the chemical etchant for a time greater than or equal to about 2 seconds to less than or equal to about 10 minutes.

In one aspect, the chemical etchant may be selected from the group consisting of: diethyl-ketone, dodecylbenzene sulfonic acid (DBSA), abietic acid, nitric, acetic, hydrofluoric, sulfuric, hydrochloric, and combinations thereof.

In one aspect, the contacting may include immersing the precursor electrochemical layer in a bath that includes the chemical etchant.

In one aspect, the contacting may include spraying the one or more surfaces of the precursor electrochemical layer with a solution that includes the chemical etchant.

In one aspect, the method may further include assembling a cell, where the cell includes the electrode.

In one aspect, the method may further include subjecting the precursor electrochemical to a grain refinement process.

In various aspects, the present disclosure provides a method for forming a portion of the electrode for use in an electrochemical cell that cycles lithium ions. The method may include forming a plurality of dimples on one or more surfaces of a lithium metal film to form the electrode. The dimples of the plurality of dimples may have an average lateral size greater than or equal to about 100 nm to less than or equal to about 100 μm, and a depth greater than or equal to about 100 nm to less than or equal to about 50 μm.

In one aspect, the dimples of the plurality of dimples may be formed in situ by applying a current to the lithium metal film. A current density of the current may be greater than or equal to about 0.1 mA/cm² to less than or equal to about 10 mA/cm². The current density may be applied for a time greater than or equal to about 1 second to less than or equal to about 20 minutes.

In one aspect, the forming may include moving a roller having a plurality of shapes defined thereon along one or more surfaces of the precursor electrochemical layer.

In one aspect, the forming may include contacting one or more surfaces of the precursor electrochemical layer and a chemical etchant. The precursor electrochemical layer may be contacted with the chemical etchant for a time greater than or equal to about 2 seconds to less than or equal to about 10 minutes.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical battery cell including a lithium metal negative electrode having a predetermined surface design defined by a plurality of dimples in accordance with various aspects of the present disclosure;

FIG. 2 is an illustration of an example lithium metal negative electrode having a predetermined surface design defined by a plurality of dimples in accordance with various aspects of the present disclosure;

FIG. 3 is a flowchart illustrating an example method for forming a lithium metal negative electrode having a predetermined surface design defined by a plurality of dimples in accordance with various aspects of the present disclosure;

FIG. 4A is a microscopic image of a lithium metal negative electrode having a predetermined surface design defined by a plurality of dimples in accordance with various aspects of the present disclosure, prepared, for example, using the method illustrated in FIG. 3;

FIG. 4B is a microscopic image of another lithium metal negative electrode having a predetermined surface design defined by a plurality of dimples in accordance with various aspects of the present disclosure, prepared, for example, using the method illustrated in FIG. 3

FIG. 4C is a microscopic image of a lithium metal negative electrode;

FIG. 5 is an illustration of another example method for forming a lithium metal negative electrode having a predetermined surface design defined by a plurality of dimples in accordance with various aspects of the present disclosure;

FIG. 6 is a flowchart illustrating another example method for forming a lithium metal negative electrode having a predetermined surface design defined by a plurality of dimples in accordance with various aspects of the present disclosure;

FIG. 7 is a graphical illustration demonstrating the discharge capacity retention (%) of the example battery prepared in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

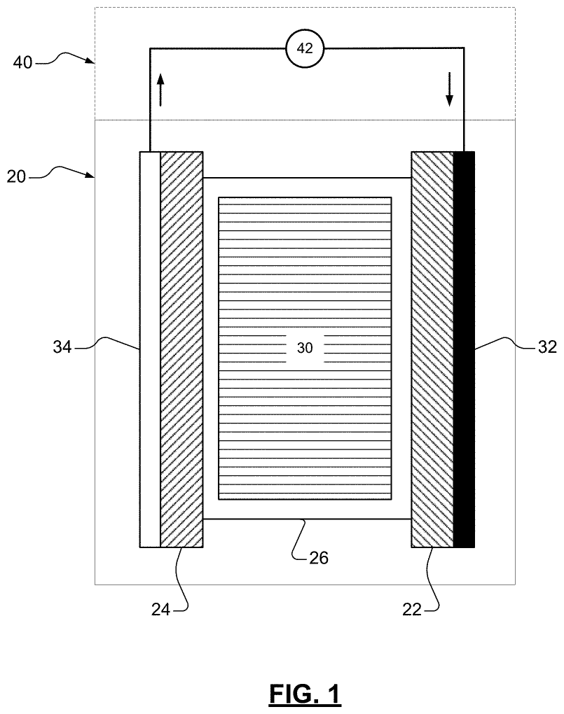

A typical lithium-ion battery includes a first electrode (such as a positive electrode or cathode) opposing a second electrode (such as a negative electrode or anode) and a separator and/or electrolyte disposed therebetween. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions and may be in liquid, gel, or solid form. For example, an exemplary and schematic illustration of an electrochemical cell (also referred to as the battery) 20 is shown in FIG. 1.

Such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single positive electrode cathode and a single anode, the skilled artisan will recognize that the present teachings extend to various other configurations, including those having one or more cathodes and one or more anodes, as well as various current collectors with electroactive layers disposed on or adjacent to one or more surfaces thereof.

The battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte or a semi-solid-state electrolyte (e.g., gel electrolyte). For example, the separator 26 may be defined by a plurality of solid-state electrolyte particles (not shown). In the instance of solid-state batteries and/or semi-solid-state batteries, the positive electrode 24 and/or the negative electrode 22 may include a plurality of solid-state electrolyte particles (not shown). The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 may be a metal foil, metal grid or screen, or expanded metal comprising copper or any other appropriate electrically conductive material known to those of skill in the art. A second current collector 34 (e.g., a positive current collector) may be positioned at or near the positive electrode 24. The second electrode current collector 34 may be a metal foil, metal grid or screen, or expanded metal comprising aluminum or any other appropriate electrically conductive material known to those of skill in the art. The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of lithium metal, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., deposited lithium metal) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), lithium bis(trifluoromethanesulfonyl)imide (LiTFSI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

In various aspects, the separator 26 may be a microporous polymeric separator. The microporous polymeric separator may include, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of polyethylene (PE) and/or polypropylene (PP). Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 μm to less than or equal to about 50 μm, and in certain instances, optionally greater than or equal to about 1 μm to less than or equal to about 20 μm. The separator 26 may have an average thickness greater than or equal to 1 μm to less than or equal to 50 μm, and in certain instances, optionally greater than or equal to 1 μm to less than or equal to 20 μm.

In each variation, the separator 26 may further include one or more ceramic materials and/or one or more heat-resistant materials. For example, the separator 26 may also be admixed with the one or more ceramic materials and/or the one or more heat-resistant materials, or one or more surfaces of the separator 26 may be coated with the one or more ceramic materials and/or the one or more heat-resistant materials. The one or more ceramic materials may include, for example, alumina (Al₂O₃), silica (SiO₂), and the like. The heat-resistant material may include, for example, Nomex, Aramid, and the like.

In various aspects, the porous separator 26 and/or the electrolyte 30 disposed in the porous separator 26 as illustrated in FIG. 1 may be replaced with a solid-state electrolyte (“SSE”) layer (not shown) and/or semi-solid-state electrolyte (e.g., gel) layer that functions as both an electrolyte and a separator. The solid-state electrolyte layer and/or semi-solid-state electrolyte layer may be disposed between the positive electrode 24 and negative electrode 22. The solid-state electrolyte layer and/or semi-solid-state electrolyte layer facilitates transfer of lithium ions, while mechanically separating and providing electrical insulation between the negative and positive electrodes 22, 24. By way of non-limiting example, the solid-state electrolyte layer and/or semi-solid-state electrolyte layer may include a plurality of solid-state electrolyte particles, such as LiTi₂(PO₄)₃, LiGe₂(PO₄)₃, Li₇La₃Zr₂O₁₂, Li₃xLa_{2/3-}xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof.

The positive electrode 24 may be formed from a lithium-based active material that is capable of undergoing lithium plating and stripping, while functioning as the positive terminal of a lithium-ion battery. The positive electrode 24 can be defined by a plurality of electroactive material particles (not shown). Such positive electroactive material particles may be disposed in one or more layers so as to define the three-dimensional structure of the positive electrode 24. The electrolyte 30 may be introduced, for example after cell assembly, and contained within pores (not shown) of the positive electrode 24. In certain variations, the positive electrode 24 may include a plurality of solid-state electrolyte particles (not shown). In each instance, the positive electrode 24 may have an average thickness greater than or equal to about 1 μm to less than or equal to about 500 μm, and in certain aspects, optionally greater than or equal to about 10 μm to less than or equal to about 200 μm. The positive electrode 24 may have an average thickness greater than or equal to 1 μm to less than or equal to 500 μm, and in certain aspects, optionally greater than or equal to 10 μm to less than or equal to 200 μm.

One exemplary common class of known materials that can be used to form the positive electrode 24 is layered lithium transitional metal oxides. For example, in certain aspects, the positive electrode 24 may comprise one or more materials having a spinel structure, such as lithium manganese oxide (Li(j₁₊ₓ)Mn₂O₄, where 0.1≤x≤1) (LMO), lithium manganese nickel oxide (LiMn₍₂₋ₓ₎NiₓO₄, where 0≤x≤0.5) (LNMO) (e.g., LiMn_{1.5}Ni_{0.5}O₄); one or more materials with a layered structure, such as lithium cobalt oxide (LiCoO₂), lithium nickel manganese cobalt oxide (Li(NiₓMn_{y}Co_{z})O₂, where 0≤x≤1, 0≤y≤1, 0≤z≤1, and x+y+z=1) (e.g., LiMn_{0.33}Ni_{0.33}Co_{0.33}O₂) (NMC), or a lithium nickel cobalt metal oxide (LiNi_{(1-x-y)}CoₓM_{y}O₂, where 0<x<0.2, y<0.2, and M may be Al, Mg, Ti, or the like); or a lithium iron polyanion oxide with olivine structure, such as lithium iron phosphate (LiFePO₄) (LFP), lithium manganese-iron phosphate (LiMn₂₋ₓFeₓPO₄, where 0<x<0.3) (LFMP), or lithium iron fluorophosphate (Li₂FePO₄F). In various aspects, the positive electrode 24 may comprise one or more electroactive materials selected from the group consisting of: NCM 111, NCM 532, NCM 622, NCM 811, NCMA, LFP, LMO, LFMP, LLC, and combinations thereof.

In certain variations, the positive electroactive material(s) in the positive electrode 24 may be optionally intermingled with an electronically conducting material that provides an electron conduction path and/or at least one polymeric binder material that improves the structural integrity of the electrode 24. For example, the positive electroactive material(s) in the positive electrode 24 may be optionally intermingled (e.g., slurry casted) with binders like polyimide, polyamic acid, polyamide, polysulfone, polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETJEN™ black or DENKA™ black), carbon fibers and nanotubes, graphene, and the like. Examples of a conductive polymer include polyaniline, polythiophene, polyacetylene, polypyrrole, and the like. In certain aspects, mixtures of the conductive materials may be used.

The positive electrode 24 may include greater than or equal to about 5 wt. % to less than or equal to about 99 wt. %, optionally greater than or equal to about 10 wt. % to less than or equal to about 99 wt. %, and in certain variations, greater than or equal to about 50 wt. % to less than or equal to about 98 wt. %, of the positive electroactive material(s); greater than or equal to 0 wt. % to less than or equal to about 40 wt. %, and in certain aspects, optionally greater than or equal to about 1 wt. % to less than or equal to about 20 wt. %, of the electronically conducting material; and greater than or equal to 0 wt. % to less than or equal to about 40 wt. %, and in certain aspects, optionally greater than or equal to about 1 wt. % to less than or equal to about 20 wt. %, of the at least one polymeric binder.

The positive electrode 24 may include greater than or equal to 5 wt. % to less than or equal to 99 wt. %, optionally greater than or equal to 10 wt. % to less than or equal to 99 wt. %, and in certain variations, greater than or equal to 50 wt. % to less than or equal to 98 wt. %, of the positive electroactive material(s); greater than or equal to 0 wt. % to less than or equal to 40 wt. %, and in certain aspects, optionally greater than or equal to 1 wt. % to less than or equal to 20 wt. %, of the electronically conducting material; and greater than or equal to 0 wt. % to less than or equal to 40 wt. %, and in certain aspects, optionally greater than or equal to 1 wt. % to less than or equal to 20 wt. %, of the at least one polymeric binder.

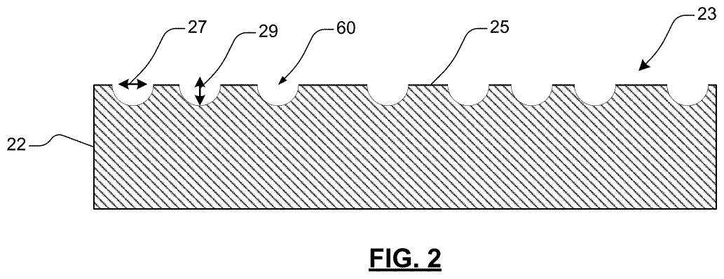

The negative electrode 22 may be formed from a lithium host material that is capable of functioning as a negative terminal of a lithium-ion battery. For example, in various aspects, the negative electrode 22 may be defined by may include lithium, for example, in certain variations, the negative electrode 22 may be defined by a lithium metal foil. In various aspects, as illustrated in FIG. 2, at least one surface 23 of the lithium metal negative electrode 22 may have a predetermined surface design comprising a plurality of dimples 60. For example, the plurality of dimples 60 may occupy greater than or equal to about 20% to less than or equal to about 90%, and in certain aspects, optionally greater than or equal to about 40% to less than or equal to about 60%, of a total surface area of the at least one surface 23 of the lithium metal negative electrode 22. In certain variations, the plurality of dimples 60 may occupy greater than or equal to 20% to less than or equal to 90%, and in certain aspects, optionally greater than or equal to 40% to less than or equal to 60%, of a total surface area of the at least one surface 23 of the lithium metal negative electrode 22.

The dimples 60 may take a variety of configurations. Generally, the dimples 60 may have a cross-sectional shape that is round, for example, circular, oval, and the like. Further, the dimples 60 may be concave with respect to one side (e.g., an exposed surface 25) of the negative electrode 22. In certain variations, the dimples 60 may be dispersed in a substantially continuous, or uniformed, manner. In other variations, the dimples 60 may be dispersed so as to define a select pattern. In sill other variations, the dimples 60 may be randomly dispersed. In each variation, however, the dimples 60 may have an average lateral size 27 (e.g., an average diameter of the plurality of dimples) of greater than or equal to about 100 nm to less than or equal to about 100 μm, and in certain aspects, optionally greater than or equal to about 1 μm to less than or equal to about 60 μm; and an average depth 29 (e.g., an average depth of the plurality of dimples) of greater than or equal to about 100 nm to less than or equal to about 50 μm, and in certain aspects, optionally greater than or equal to about 500 nm to less than or equal to about 10 μm. In certain variations, the dimples 60 may have an average lateral size 27 (e.g., an average diameter of the plurality of dimples) of greater than or equal to 100 nm to less than or equal to 100 μm, and in certain aspects, optionally greater than or equal to 1 μm to less than or equal to 60 μm; and an average depth 29 (e.g., an average depth of the plurality of dimples) of greater than or equal to 100 nm to less than or equal to 50 μm, and in certain aspects, optionally greater than or equal to 500 nm to less than or equal to 10 μm.

The dimples 60 have a lower energy surface as compared to the flat regions (i.e., non-dimpled) of the surface (e.g., the exposed surface 25) of the lithium metal film. As such, the dimples 60 provide preferential sites for lithium nucleation during lithium deposition (i.e., during charging of the battery 20) and/or growth during operation of the battery 20 and help to inhibit or reduce the formation of comparatively large lithium metal dendrites. That is, the dimples 60 encourage more widespread formation and/or growth of lithium metal dendrites, such that lithium metal dendrites as formed are smaller, as compared to flat surfaces, where fewer larger dendrites are often formed.

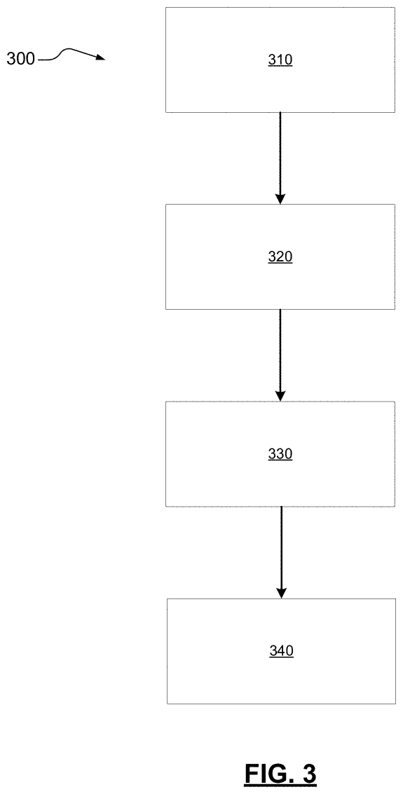

In various aspects, the present disclosure provides methods for forming lithium metal negative electrodes having surface designs for preferential lithium nucleation during cell operation, like the lithium metal negative electrode illustrated in FIGS. 1 and 2. For example, FIG. 3 sets forth an example method 300 for forming a negative electrode having a surface design for preferential lithium nucleation during cell operation. In various aspects, the method 300 is an in-situ electrochemical method that includes, for example, stripping 330 lithium ions from one or more lithium metal negative electrodes following cell fabrication by applying a current having a current density greater than or equal to about 0.1 mA/cm² to less than or equal to about 10 mA/cm², and in certain aspects, optionally greater than or equal to about 1 mA/cm² to less than or equal to about 8 mA/cm². In certain variations, the applied current density may be greater than or equal to 0.1 mA/cm² to less than or equal to 10 mA/cm², and in certain aspects, optionally greater than or equal to 1 mA/cm² to less than or equal to 8 mA/cm². By way of comparison only, for standard formation, current densities are typically greater than or equal to about 0.2 mA/cm² to less than or equal to about 0.5 mA/cm². In the current instance, the (higher) current density may be applied for a time (e.g., stripping time) greater than or equal to about 1 second to less than or equal to about 20 minutes, and in certain aspects, optionally greater than or equal to about 30 seconds to less than or equal to about 10 minutes. In certain variations, the (higher) current density may be applied for a time (e.g., stripping time) greater than or equal to 1 second to less than or equal to 20 minutes, and in certain aspects, optionally greater than or equal to 30 seconds to less than or equal to 10 minutes. Dimples are formed in the lithium metal negative electrode, as lithium is removed (i.e., stripped) from the lithium metal anode. The current density and/or densities, and also the time period, are selected to control the number and size of the dimples.

In certain variations, the method 300 may include assembling 320 a battery cell that includes one or more lithium metal negative electrodes. In still further variations, the method 300 may include refining 310 the microstructures of the one or more lithium metal negative electrode. For example, in certain variations, refining 310 includes increasing the number of grain boundaries, where the preferential dimpling occurs during stripping 330. As the skilled artisan will recognize, grain boundary (heterogeneous) nucleation requires less energy than homogeneous nucleation. The microstructures of the one or more lithium metal negative electrode 310 may be refined 310 using particular refinement processes. For example, in various aspects, grain refinement processes can include cold rolling, multipass rolling, cross rolling, and the like. In still further variations, the method 300 may further include applying 340 a standard formation protocol to the cell following the lithium stripping 330. The standard formation protocol may include, in certain variations, charging and discharging the cell one or more times at comparatively slow rates (e.g., C/20 or C/10).

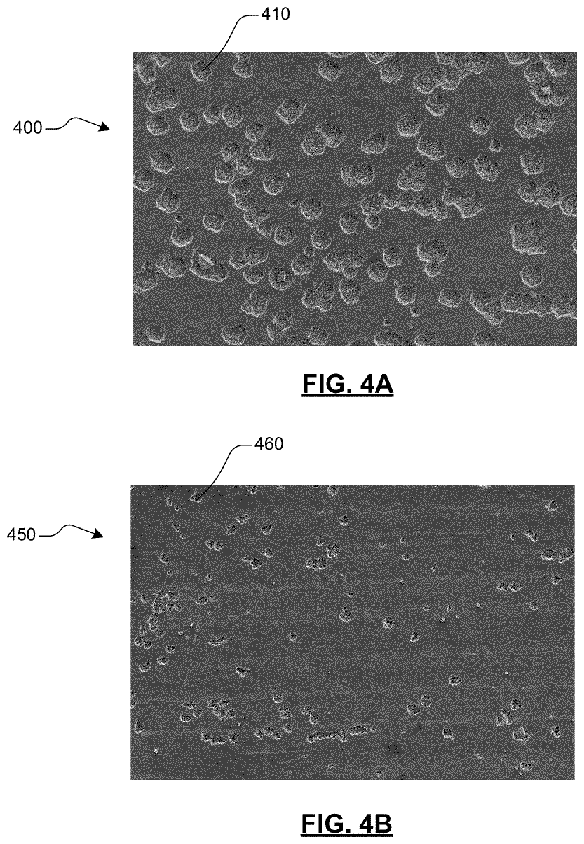

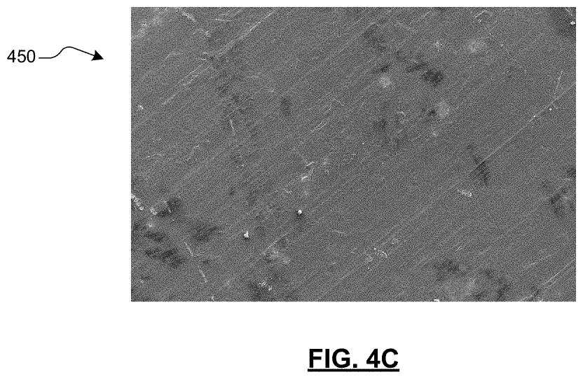

The in-situ electrochemical method 300, including the stripping 330, and optionally the assembling 320 and/or refining 310, can be readily integrated into existing negative electrode designs and formation processes, including, for example only, lithium metal mesh anodes. FIG. 4A is a microscopic image of a lithium metal negative electrode 400 having a predetermined surface design defined by a plurality of dimples 410 prepared, for example, using the method 300 illustrated in FIG. 3. FIG. 4B is a microscopic image of a lithium metal negative electrode 450 having a predetermined surface design defined by a plurality of dimples 460 prepared, for example, using the method 300 illustrated in FIG. 3. The lithium metal negative electrode 400 is treated for about 5 minutes at about 4.5 mA/cm², whereas the lithium metal negative electrode 450 was treated for about 2 minutes at about 4.5 mA/cm². By way of comparison only, FIG. 4C is a microscopic image of an untreated lithium metal negative electrode 490.

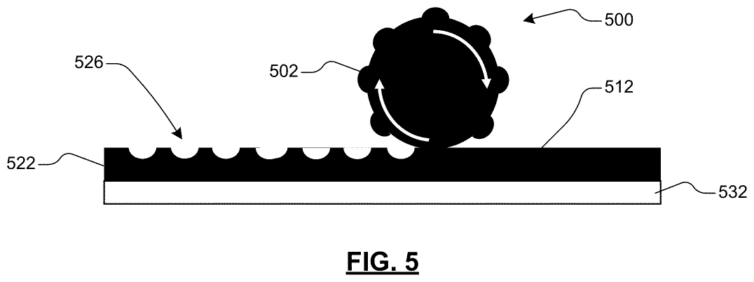

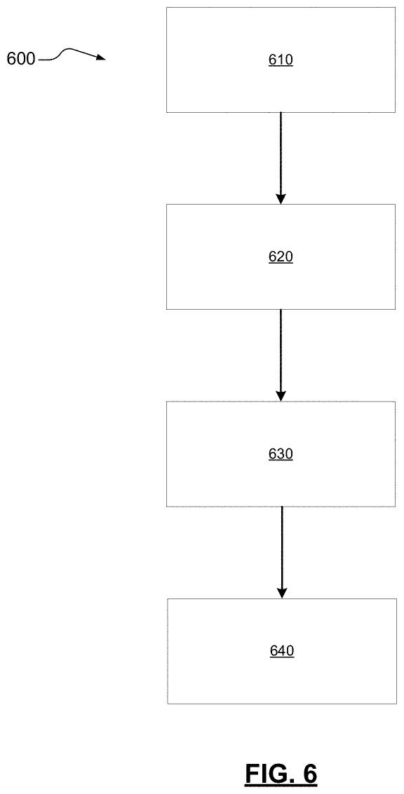

FIG. 5 illustrates another example method for forming a negative electrode having a surface design for preferential lithium nucleation during cell operation. In various aspects, the method is a mechanical method that includes, for example, using a rolling process to introduce a plurality of dimples 526 on one or more surfaces of a lithium metal negative electrode 522, where the rolling process includes, as illustrated, contacting a roller 500 having defined shapes 502 with one or more surfaces 512 of the lithium metal negative electrode 522 to form the dimples 526. As illustrated, the lithium metal negative electrode 522 may be disposed on or near a current collector 532, and contacting may include, for example, moving or rolling the roller along the lithium metal negative electrode 522. The roller 500 may be configured to apply a pressure greater than or equal to about 2 MPa to less than or equal to about 50 MPa. Although circular shapes are illustrated in FIG. 5, the skilled artisan will appreciate that in various instances the defined shapes 502 may take a variety of configurations and spacings so to form dimples having a variety of shapes and sizes, and that form a variety of patterns on the surface of the lithium metal negative electrode 522. Although not illustrated, in certain variations, the method may further include assembling a cell and incorporating therewithin the lithium metal negative electrode 522 including the plurality of dimples 526. Further, as in the instance of method 400 detailed above, the mechanical method may include refining the microstructure of the lithium metal negative electrode 522 prior to the mechanical or rolling process and/or applying a standard formation protocol to the cell following cell assembly. Further still, in certain variations, the method may include disposing the lithium metal negative electrode 522 on or near the one or more surfaces of the current collector 532.

FIG. 6 illustrates another example method 600 for forming a negative electrode having a surface design for preferential lithium nucleation during cell operation. In various aspects, the method 600 is a chemical method that includes, for example, contacting 620 one or more surfaces of a lithium metal negative electrode with a chemical etchant selected to introduce simples into the one or more surfaces of the lithium metal negative electrode, and more particularly, at grain boundaries. The chemical etchant may be selected from the group consisting of: diethyl-ketone, dodecylbenzene sulfonic acid (DBSA), abietic acid, nitric, acetic, hydrofluoric, sulfuric, hydrochloric, and combinations thereof.

In certain variations, the contacting 620 of the one or more surfaces of the lithium metal negative electrode with the chemical etchant may include a bath process, where the lithium metal negative electrode is immersed in a solution including the chemical etchant. The solution may further include an anhydrous alcohol (e.g., ethanol, methanol, isopropanol, and the like). The solution may include greater than 0 wt. % to less than or equal to about 30 wt. %, optionally greater than 0 wt. % to less than or equal to about 10 wt. %, and in certain aspects, optionally greater than 0 wt. % to less than or equal to about 5 wt. %, of the chemical etchant. The solution may include greater than 0 wt. % to less than or equal to 30 wt. %, optionally greater than 0 wt. % to less than or equal to 10 wt. %, and in certain aspects, optionally greater than 0 wt. % to less than or equal to 5 wt. %, of the chemical etchant

In other variations, the contacting 620 of the one or more surfaces of the lithium metal negative electrode with the chemical etchant may include spraying the chemical etchant, or a solution including the chemical etchant, onto the one or more surfaces of the lithium metal negative electrode. The solution may include greater than 0 wt. % to less than or equal to about 30 wt. %, optionally greater than 0 wt. % to less than or equal to about 10 wt. %, and in certain aspects, optionally greater than 0 wt. % to less than or equal to about 5 wt. %, of the chemical etchant. The solution may include greater than 0 wt. % to less than or equal to 30 wt. %, optionally greater than 0 wt. % to less than or equal to 10 wt. %, and in certain aspects, optionally greater than 0 wt. % to less than or equal to 5 wt. %, of the chemical etchant.

In each instance, the chemical etchant may be kept in contact with the one or more surfaces of the lithium metal negative electrode for a period greater than or equal to about 2 seconds to less than or equal to about 10 minutes, and in certain aspects, optionally greater than or equal to about 5 seconds to less than or equal to about 5 minutes. In certain variations, the chemical etchant may be kept in contact with the one or more surfaces of the lithium metal negative electrode for a period greater than or equal to 2 seconds to less than or equal to 10 minutes, and in certain aspects, optionally greater than or equal to 5 seconds to less than or equal to 5 minutes.

In each instance, the contacting 620 of the of the one or more surfaces of the lithium metal negative electrode may occur at a temperature greater than or equal to about −40° C. to less than or equal to about 60° C., and in certain aspects, optionally greater than or equal to −40° C. to less than or equal to 60° C.

In various aspects, like the method 400, the method 600 may further include refining 610 the microstructure of the lithium metal negative electrode prior to the contacting 620 of the lithium metal negative electrode and the chemical etchant. Further, in certain variations, the method 600 may include assembling 630 a cell and incorporating therewithin the lithium metal negative electrode including the plurality of dimples as formed by the chemical process. Further still, in certain variations, like the method 400, the method 600 may include applying 640 a standard formation protocol to the cell following cell assembly. Although not illustrated, the skilled artisan will recognize that in certain variations, the method 600 may include rinsing the lithium metal negative electrode following the contacting 620 to remove excess materials, like excess chemical etchant.

Certain features of the current technology are further illustrated in the following non-limiting examples.

### Example 1

Example battery cells may be prepared in accordance with various aspects of the present disclosure.

For example, an example battery cell 610 may include a lithium metal negative electrode having a predetermined surface design defined by a plurality of dimples, like the lithium metal electrode 22 illustrated in FIGS. 1 and 2. A comparative battery 620 may include an untreated lithium metal negative electrode.

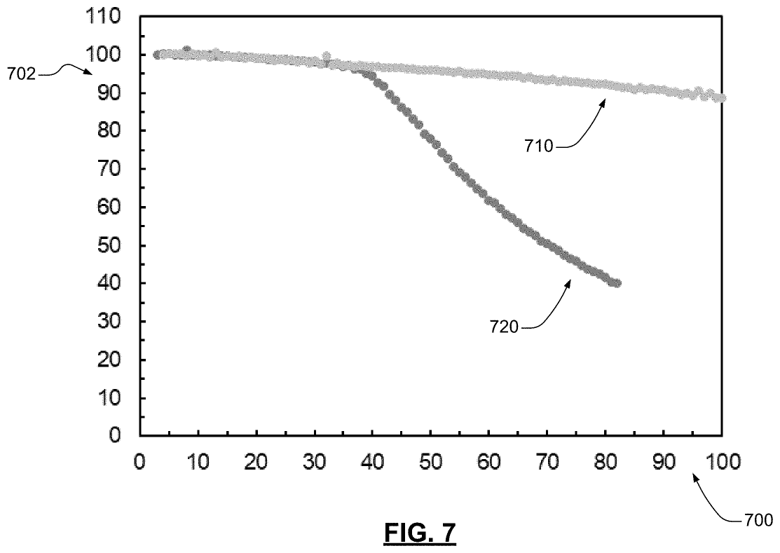

FIG. 7 is a graphical illustration demonstrating the discharge capacity retention (%) of the example battery 710 as compared to the comparative battery cell 720, where the x-axis 700 represents cycle number, and the γ-axis 702 represents discharge capacity retention (%). As illustrated, the example battery cell 710 has improved cell performance, including both cell discharge capacity and cell cycle stability, which is evidenced by the flattening of the curve with high values, as a function of cycle number.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode for use in an electrochemical cell that cycles lithium ions, the electrode comprising:
an electrochemical layer comprising lithium metal and defining a surface that defines a plurality of dimples having an average lateral size greater than or equal to about 100 nm to less than or equal to about 100 μm, and an average depth greater than or equal to about 100 nm to less than or equal to about 50 μm.

2. The electrode of claim 1, wherein the dimples of the plurality of dimples occupy greater than or equal to about 20% to less than or equal to about 90% of a total surface area of the one or more surfaces.

3. The negative electrode of claim 1, wherein the dimples of the plurality of dimples are randomly distributed on the one or more surfaces of the electrochemical layer.

4. The electrode of claim 1, wherein the dimples of the plurality of dimples are dispersed with a uniform density on the one or more surfaces of the electrochemical layer.

5. The electrode of claim 1, wherein the dimples of the plurality of dimples define one or more patterns along the one or more surfaces of the electrochemical layer.

6. A method for forming an electrode for use in an electrochemical cell that cycles lithium ions, the method comprising:
forming a plurality of dimples on one or more surfaces of a precursor electrochemical layer to form an electrochemical layer, the electrochemical layer comprising lithium metal and the dimples of the plurality of dimples having an average lateral size greater than or equal to about 100 nm to less than or equal to about 100 μm, and a depth greater than or equal to about 100 nm to less than or equal to about 50 μm, wherein the electrode comprises the electrochemical layer.

7. The method of claim 6, wherein the forming comprises:
applying a current density greater than or equal to about 0.1 mA/cm² to less than or equal to about 10 mA/cm² to the precursor electrochemical layer, wherein the current density is applied for a time greater than or equal to about 1 second to less than or equal to about 20 minutes.

8. The method of claim 7, the method further comprising:
assembling a cell that comprises the precursor electrochemical layer.

9. The method of claim 6, wherein the forming comprises:
moving a roller having a plurality of shapes defined thereon along one or more surfaces of the precursor electrochemical layer.

10. The method of claim 9, the method further comprising:
assembling a cell that comprises the electrode.

11. The method of claim 6, wherein the forming comprises:
contacting one or more surfaces of the precursor electrochemical layer and a chemical etchant, wherein the precursor electrochemical layer is contacted with the chemical etchant for a time greater than or equal to about 2 seconds to less than or equal to about 10 minutes.

12. The method of claim 11, wherein the chemical etchant is selected from the group consisting of: diethyl-ketone, dodecylbenzene sulfonic acid (DBSA), abietic acid, nitric, acetic, hydrofluoric, sulfuric, hydrochloric, and combinations thereof.

13. The method of claim 11, wherein the contacting comprises:
immersing the precursor electrochemical layer in a bath comprising the chemical etchant.

14. The method of claim 11, wherein the contacting comprises:
spraying the one or more surfaces of the precursor electrochemical layer with a solution comprising the chemical etchant.

15. The method of claim 11, the method further comprising:
assembling a cell that comprises the electrode.

16. The method of claim 6, the method further comprising:
subjecting the precursor electrochemical to a grain refinement process.

17. A method for forming an electrode for use in an electrochemical cell that cycles lithium ions, the method comprising:
forming a plurality of dimples on one or more surfaces of a lithium metal film to form a portion of the electrode, wherein the dimples of the plurality of dimples have an average lateral size greater than or equal to about 100 nm to less than or equal to about 100 μm, and a depth greater than or equal to about 100 nm to less than or equal to about 50 μm.

18. The method of claim 17, wherein the dimples of the plurality of dimples are formed in situ by applying a current to the lithium metal film, wherein a current density of the current is greater than or equal to about 0.1 mA/cm² to less than or equal to about 10 mA/cm², and the current density is applied for a time greater than or equal to about 1 second to less than or equal to about 20 minutes.

19. The method of claim 19, wherein the forming comprises:
moving a roller having a plurality of shapes defined thereon along one or more surfaces of the precursor electrochemical layer.

20. The method of claim 19, wherein the forming comprises:
contacting one or more surfaces of the precursor electrochemical layer and a chemical etchant, wherein the precursor electrochemical layer is contacted with the chemical etchant for a time greater than or equal to about 2 seconds to less than or equal to about 10 minutes.
